(19) United States
(12) Patent Application Publication
(10) Pub. No.: US 2016/0335213 A1
(43) Pub. Date: Nov. 17, 2016

(54) MOTHERBOARD WITH MULTIPLE INTERFACES

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MENG-LIANG YANG, Shenzhen (CN)

(21) Appl. No.: 14/794,978

(22) Filed: Jul. 9, 2015

(30) Foreign Application Priority Data
May 13, 2015 (CN) 201510241550.7

(51) Int. Cl. G06F 13/40; G06F 13/16; G06F 13/362

(52) U.S. Cl. CPC G06F 13/4022; G06F 13/3625; G06F 13/16; G06F 13/4068

(57) ABSTRACT

A motherboard includes a host chip, switch chip, and a number of components having different inter integrated circuit (12C) interfaces. The switch chip couples to the host chip through a first 12C bus. The components having different 12C interfaces can couple to the switch chip through different 12C buses.

### FIELD

The subject matter herein generally relates to a motherboard with multiple interfaces.

### BACKGROUND

An inter integrated circuit (I2C) interface, including a clock signal pin and a data signal pin, can be used to performing communication between different components. The different components may include various interfaces, such as an open-drain interface and/or a push-pull interface.

### BRIEF DESCRIPTION OF THE DRAWINGS

Implementations of the present technology will now be described, by way of example only, with reference to the attached figures.

FIG. 1 is a circuit diagram of a first embodiment of a motherboard of the present disclosure.

FIG. 2 is a circuit diagram of a second embodiment of the motherboard of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

The present disclosure is described in relation to a motherboard having different type inter integrated circuit (I2C) interfaces.

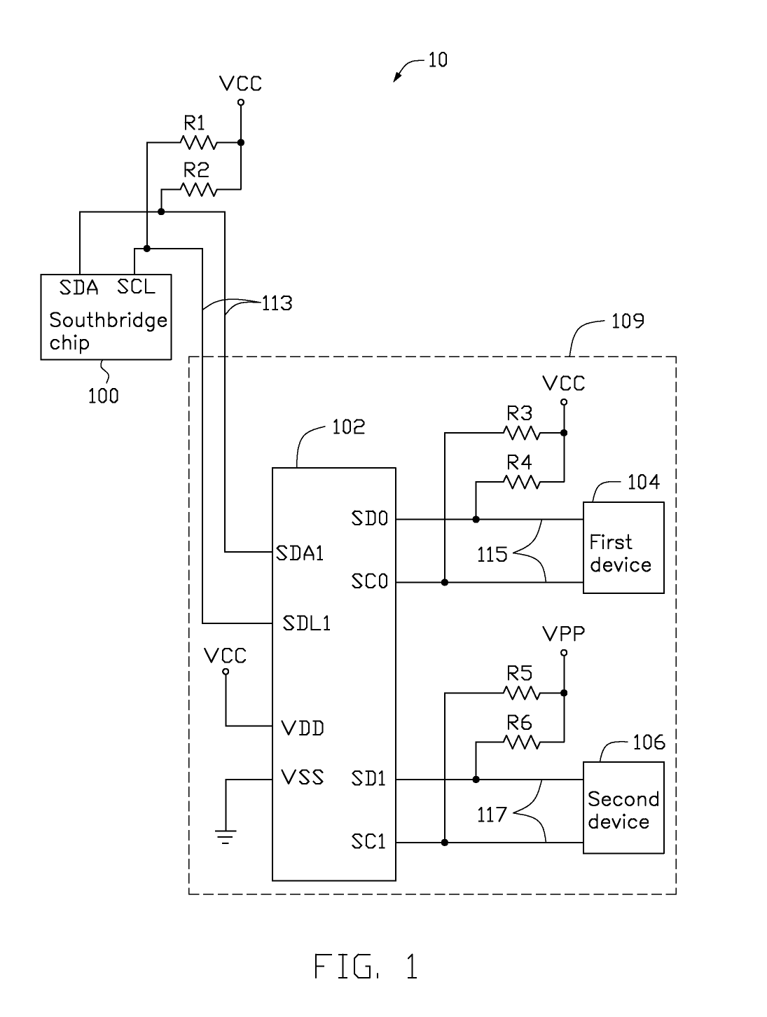

FIG. 1 illustrates a first embodiment of a motherboard 10 of the present disclosure. The motherboard 10 can comprise a interface circuit 109. The interface circuit 109 can comprise a switch chip 102 being capable of communicating a host chip through a first bus 113, a first device 104 coupled to the switch chip 102 through a second bus 115, and a second device 106 coupled to the switch chip 102 through a third bus 117. In one embodiment, the first bus 113, the second bus 115, and the third bus 117 can be an I2C bus, each of which can comprise a clock signal line and a data signal line. In one embodiment, the first device 104 can be a display chip with an open-drain I2C interface, the second device 106 can be a power chip with a push-pull I2C interface. In one embodiment, the host chip can be a southbridge chip 100. In other embodiments, the host chip can be a integrated baseboard management controller (IBMC) chip, or other chips with I2C function.

In one embodiment, the southbridge chip 100 can comprise a first clock pin SCL and a first data pin SDA. A second clock pin SDL1 of the switch chip 102 can couple to the first clock pin SCL through the first bus 113. A second data pin SDA1 of the switch chip 102 can couple to the first data pin SDA of the southbridge chip 100 through the first bus 113. The first clock pin SCL of the southbridge chip 100 can couple to a power terminal VCC through a resistor R1, the first data pin SDA can couple to the power terminal VCC through a resistor R2.

The switch chip 102 can further comprise a third clock pin SC0, a third data pin SD0, a fourth clock pin SC1, a fourth data pin SD1, a power pin VDD, and a ground pin VSS. The third clock pin SC0 can couple to the power terminal VCC through a resistor R3, and the third data pin SD0 can couple to the power terminal VCC through a resistor R4. The fourth clock pin SC1 can couple to a power terminal VPP through a resistor R5, and the fourth data pin SD1 of the switch chip 102 can couple to the power terminal VPP through a resistor R6. In one embodiment, the voltage of the power terminal VCC is 3.3 voltages, the voltage of the power terminal VPP is 5 voltages. The first device 104 and the second device 106 can communicate with the southbridge chip 100 through an I2C protocol.

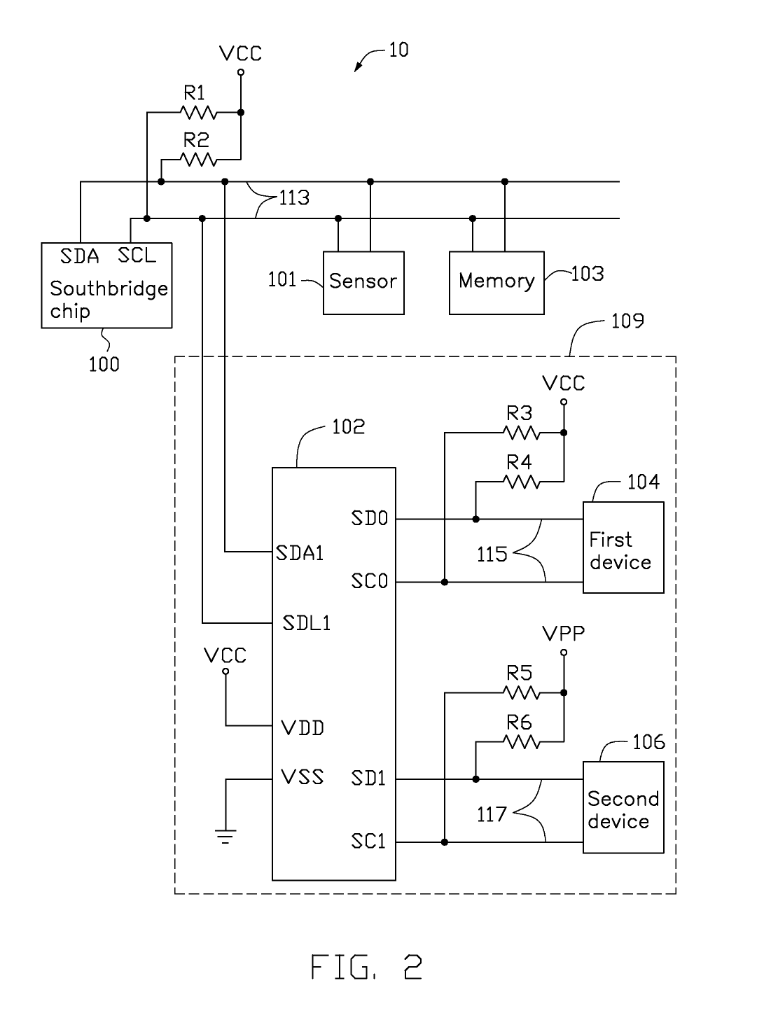

FIG. 2 illustrates a second embodiment of the motherboard 10 of the present disclosure. As comparing to the first embodiment of the motherboard 10, the second motherboard 10 can further comprise a sensor 101 and a memory 103. The sensor 101 and the memory 103 are both coupled to the first bus 113, to communicate with the southbridge chip 100. The southbridge chip 100 can obtain temperature of the motherboard 10 through the sensor 101, and obtain configuration information of the memory 103 through the first bus 113. In one embodiment, the sensor 101 and the memory 103 are both having the open-drain interfaces.

In one embodiment, the switch chip 102 can control the communication between the first device 104 and the southbridge chip 100, and control the communication between the second device 106 and the southbridge chip 100, thereby making the devices with different I2C interfaces being capable of communicate with the host device through the first bus 113.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A circuit comprising:
a switch chip coupled to a first inter integrated circuit (I2C) bus and configured to convert the first inter integrated circuit (I2C) bus into a second I2C bus and a third I2C bus;
a first device coupled to the second I2C bus; and
a second device coupled to the third I2C bus.

2. The circuit of claim 1, wherein the first device has an open-drain I2C interface, the second device has a push-pull I2C interface.

3. The circuit of claim 1, wherein the switch chip comprises a first clock pin and a first data pin;
wherein the first clock and data pins of the switch chip are coupled to the first I2C bus, a second clock and data pins of the switch chip are coupled to the second I2C bus, the second clock and data pins of the switch chip are coupled to a first power terminal through a resistor, respectively.

4. The circuit of claim 3, wherein the first device has an open-drain I2C interface, the second device has push-pull I2C interface.

5. The circuit of claim 3, wherein the switch chip further comprises a third clock pin and a third data pin, wherein the third clock and data pins of the switch chip are coupled to the third I2C bus, and the third clock and data pins of the switch chip are coupled to a second power terminal through a resistor, respectively.

6. The circuit of claim 5, wherein the first device has an open-drain I2C interface, the second device has push-pull I2C interface.

7. The circuit of claim 5, wherein the first power terminal provides 3.3 voltages, the second power terminal provides 5 voltages.

8. The circuit of claim 7, wherein the first device has an open-drain I2C interface, the second device has push-pull I2C interface.

9. A motherboard, comprising:
a host device;
a switch chip configured to convert a first inter integrated circuit (I2C) bus into a second I2C bus and a third I2C bus, wherein the switch chip is coupled to the host device through the first I2C bus;
a first device coupled to the second I2C bus; and
a second device coupled to the third I2C bus.

10. The motherboard of claim 9, wherein the first device has an open-drain I2C interface, the second device has a push-pull I2C interface.

11. The motherboard of claim 9, wherein the host device comprises a first clock pin and a first data pin, the first clock and data pins of the host device are coupled to the first I2C bus, and coupled to a first power terminal through a resistor, respectively; the switch chip comprises a second clock pin and a second data pin; wherein the first clock and data pins of the switch chip are coupled to the second I2C bus, third clock and data pins of the switch chip are coupled to the second I2C bus, and the third clock and data pins of the switch chip are coupled to the first power terminal through a resistor, respectively.

12. The motherboard of claim 11, wherein the first device has an open-drain I2C interface, the second device has push-pull I2C interface.

13. The motherboard of claim 11, wherein the switch chip further comprises a fourth clock pin and a fourth data pin, wherein the fourth clock and data pins of the switch chip are coupled to the third I2C bus, the fourth clock and data pins of the switch chip are coupled to a second power terminal through a resistor, respectively.

14. The motherboard of claim 13, wherein the first device has an open-drain I2C interface, the second device has push-pull I2C interface.

15. The motherboard of claim 13, wherein the first power terminal provides 3.3 voltages, the second power terminal provides 5 voltages.

16. The motherboard of claim 15, wherein the first device has an open-drain I2C interface, the second device has push-pull I2C interface.

17. The motherboard of claim 16, further comprising:
a sensor; and
a memory;
wherein the sensor and memory are coupled to the first I2C bus.
